(19) United States
(12) Patent Application Publication
(10) Pub. No.: US 2019/0340583 A1
(43) Pub. Date: Nov. 7, 2019

(54) SYSTEM AND METHOD FOR OPTIMIZING ROUTING OF A SCHEME OF TRANSACTIONS OVER A COMPUTER NETWORK

(71) Applicant: Source Ltd., Valletta (MT)

(72) Inventors: Ilya DUBINSKY, Kefar Sava (IL); Shmuel Ur, Shorashim (IL)

(73) Assignee: Source Ltd., Valletta (MT)

(21) Appl. No.: 16/255,871

(22) Filed: Jan. 24, 2019

Related U.S. Application Data
(63) Continuation-in-part of application No. 15/968,771, filed on May 2, 2018.

(51) Int. Cl. G06Q 20/02; G06N 3/04; G06N 3/08

(52) U.S. Cl. CPC G06Q 20/027; G06N 3/08; G06N 3/04

(57) ABSTRACT

A system and method of routing transactions within a computer network, by at least one processor may include: receiving a transaction request to route a transaction between a source node and destination node of the computer network; identifying a plurality of available routing paths for propagating the transaction between the source node and destination node; obtaining transaction parameters for each available routing path; receiving a set of preference weights including one or more preference weights, each corresponding to a transaction parameter; selecting one or more routing paths from the plurality of available routing paths, based on the one or more transaction parameters and respective preference weights; producing a routing scheme, comprising an ordered list of the one or more selected routing paths, according to the received set of preference weights; and routing the requested transaction through nodes of the computer network according to the routing scheme.

### RELATED APPLICATION DATA

The present application is a continuation-in-part (CIP) of prior U.S. application Ser. No. 15/968,771 filed on May 2, 2018, entitled “SYSTEM AND METHOD FOR OPTIMIZING ROUTING OF TRANSACTIONS OVER A COMPUTER NETWORK”, incorporated herein by reference in its entirety.

### FIELD OF THE INVENTION

The present invention relates to data transfer. More particularly, the present invention relates to systems and methods for optimizing data routing in a computer network.

### BACKGROUND OF THE INVENTION

Data transfer in computer systems is typically carried out in a single format (or protocol) from a first node to a second predetermined node of the computer system. In order to transfer data of different types (or different protocols) to the same end point, different computer systems are typically required with each computer system carrying out data transfer in a different data format.

Moreover, while current computer systems have complex architecture with multiple computing nodes, for instance all interconnected via the internet (e.g., in a secure connection), data routing is not optimized. For example, transferring a video file between two computers, or transferring currency between two bank accounts, is typically carried out in a session with a single format and routed within the computer network without consideration to minimal resource consumption.

In the financial field, modern merchants, in both online and offline stores, often utilize a payment services provider that supports a single, uniform interface (with a single format) towards the merchant but can connect to multiple payment methods and schemes on the back end. Payment service providers relay transactions to other processing entities and, ultimately, transaction processing is handled by one or more banks that collect the funds, convert currency, handle possible disputes around transactions and finally transfer the money to merchant account(s).

A payment service provider may be connected to multiple banks located in different geographic areas, which can process the same payment instruments but under varying local rules. Furthermore, different banks can provide different currency conversion rates and pay merchants at varying frequencies and with varying fund reserve requirements. In addition to financial differences, banks and processing solutions may differ in quantity of approved transactions (decline rates), quantity of fraud-related transactions that solutions fail to identify and quantity of disputes that occur with regard to these transactions later. Merchants may have different preferences with regards to the characteristics of their processing solution. Some would prefer to pay as little as possible, dealing with occasional fraud case but seeing higher approval rates, while others would prefer to be conservative with regards to fraud, even at expense of higher transaction fees.

### SUMMARY OF THE INVENTION

Embodiments of the present invention include a system and a method for routing transactions between nodes of a computer network, in which each node may be connected to at least one other node via one or more links. The system may include for example a clustering model; at least one neural network; a routing engine; and at least one processor.

The at least one processor may be configured to: receive a request to route a transaction between two nodes of the computer network; extract from the transaction request, a feature vector (FV), that may include at least one feature; and associate the requested transaction with a cluster of transactions in the clustering model based on the extracted FV.

The neural network may be configured to produce a selection of an optimal route for the requested transaction from a plurality of available routes, based on the FV, and the routing engine may be configured to route the requested transaction through the computer network according to the selection.

According to some embodiments, the clustering model may be configured to: accumulate a plurality of FVs, each including at least one feature associated with a respective received transaction; cluster the plurality of FVs to clusters, according to the at least one feature; and associate at least one other requested transaction with a cluster, according to a maximum-likelihood best fit of the at least one other requested transaction's FV.

The at least one processor may be configured to attribute at least one group characteristic (GC) to the requested transaction, based on the association of the requested transaction with the cluster. The neural network may be configured to produce a selection of an optimal route for the requested transaction from a plurality of available routes, based on at least one of the FV and GC.

According to some embodiments, the GC may be selected from a list consisting of: decline propensity, fraud propensity, chargeback propensity and expected service time.

According to some embodiments, the neural network may be configured to select an optimal route for the requested transaction from a plurality of available routes, based on at least one of the FV and GC and at least one weighted user preference.

The at least one processor may be configured to calculate at least one cost metric. The neural network may be configured to select an optimal route for the requested transaction from a plurality of available routes, based on at least one of the FV and GC, at least one weighted user preference, and the at least one calculated cost metric.

According to some embodiments, the at least one cost metric may be selected from a list consisting of: transaction fees per at least one available route, currency conversion spread and markup per the at least one available route and net present value (NPV) of the requested transaction per at least one available route.

According to some embodiments, each cluster of the clustering model may be associated with a respective neural network module, and each neural network module may be configured to select at least one routing path for at least one specific transaction associated with the respective cluster.

Embodiments of the invention may include a method of routing transactions within a computer network. The method may include: receiving, by a processor, a request to route a transaction between two nodes of the computer network, each node connected to at least one other node via one or more links; extracting from the transaction request, an FV, including at least one feature associated with the requested transaction; associating the requested transaction with a cluster of transactions in a clustering model based on the extracted FV; selecting an optimal route for the requested transaction from a plurality of available routes, based on the FV; and routing the requested transaction according to the selection.

According to some embodiments, associating the requested transaction with a cluster may include: accumulating a plurality of FVs, each including at least one feature associated with a respective received transaction; clustering the plurality of FVs to clusters in the clustering model, according to the at least one feature; and associating at least one other requested transaction with a cluster according to a maximum-likelihood best fit of the at least one other requested transaction's FV.

According to some embodiments, attributing at least one GC to the requested transaction may include: calculating at least one GC for each cluster; and attributing the received request the at least one calculated GC based on the association of the requested transaction with the cluster.

According to some embodiments, selecting an optimal route for the requested transaction from a plurality of available routes may include: providing at least one of an FV and a GC as a first input to a neural-network; providing at least one cost metric as a second input to the neural-network; providing the plurality of available routes as a third input to the neural-network; and obtaining, from the neural-network a selection of an optimal route based on at least one of the first, second and third inputs.

According to some embodiments, selecting an optimal route for the requested transaction from a plurality of available routes may include for example providing at least one transaction parameter (e.g., one or more of an FV, a GC and a cost metric) as a first input to a neural-network (NN); providing at least one respective preference weight as a second input to the NN; providing the plurality of available routes as a third input to the neural-network; and obtaining, from the NN a selection of one or more optimal routing paths based on at least one of the first, second and third inputs.

According to some embodiments, providing at least one cost metric may include at least one of: calculating transaction fees per at least one available route; calculating currency conversion spread and markup per the at least one available route; and calculating net present value of the requested transaction per at least one available route. Embodiments may further include receiving at least one weight value and determining the cost metric per the at least one available route based on the calculations and the at least one weight value.

Embodiments of the present invention may include a system and a method of routing transactions within a computer network, by at least one processor. Embodiments of the method may include:

receiving a transaction request to route a transaction between a source node and destination node of the computer network;

identifying a plurality of available routing paths for propagating the transaction between the source node and destination node based on the transaction request;

obtaining one or more transaction parameters for each available routing path, based on the transaction request;

receiving a set of preference weights that may include one or more preference weights and where each preference weight of the received set of preference weights may correspond to a transaction parameter;

selecting one or more routing paths from the plurality of available routing paths, based on the one or more transaction parameters and respective preference weights;

producing a routing scheme, that may include an ordered list of the one or more selected routing paths, according to the received set of preference weights; and

routing the requested transaction through nodes of the computer network according to the routing scheme.

In some embodiments of the present invention, obtaining one or more transaction parameters may include:

extracting from the transaction request, a feature vector (FV), that may include at least one feature associated with the requested transaction;

associating the requested transaction with a cluster of transactions in a clustering model based on the extracted FV; and

attributing at least one group characteristic (GC) to the requested transaction, based on the association of the requested transaction with the cluster.

In some embodiments of the present invention, obtaining one or more transaction parameters may include calculating at least one cost metric. The cost metric may be selected from a list that may include:

transaction success fees per at least one available route;

transaction failure fees per at least one available route;

transaction cancellation per at least one available route;

currency conversion spread per the at least one available route;

currency conversion markup per the at least one available route; and

net present value (NPV) of the requested transaction per the at least one available route.

The one or more transaction parameters may include at least one of: a feature of the FV, a GC parameter and a cost metric.

Selecting one or more routing paths from the plurality of available routing paths may include:

providing at least one transaction parameter as a first input to a neural-network (NN);

providing at least one respective preference weight as a second input to the NN;

providing the plurality of available routes as a third input to the neural-network; and

obtaining, from the NN a selection of one or more optimal routing paths based on at least one of the first, second and third inputs.

Embodiments of the method may include:

perturbating a value of one or more preference weights of the received set of preference weights, to produce one or more perturbated sets of preference weights;

for each set of the received set of preference weights and the one or more perturbated sets of preference weights, providing the preference weights as the second input to the NN and obtaining, from the NN, a selection of an optimal routing path from the plurality of available routing paths.

According to some embodiments, routing the requested transaction through nodes of the computer network according to the routing scheme may include attempting to route the requested transaction in a serial sequence, one routing path after the other, according to the ordered list of the one or more selected routing paths.

Alternately, or additionally, routing the requested transaction through nodes of the computer network according to the routing scheme may include attempting to route the requested transaction in a parallel sequence, through two or more routing paths, according to the ordered list of the one or more selected routing paths.

Alternately, or additionally, routing the requested transaction through nodes of the computer network according to the routing scheme may include attempting to route the requested transaction in a combination of a parallel sequence and a serial sequence, according to the ordered list of the one or more selected routing paths.

Routing the requested transaction may be limited by a timeframe, and the ordered list may be ordered based on at least one of: the timeframe and a completion time of at least routing attempt.

Embodiments of the method may further include calculating a dependent probability of success between different routing paths. The ordered list may be ordered according to the calculated dependent probability of success.

If a routing of the requested transaction through a first routing path fails, then the routing scheme may be amended according to the dependent probability of success, so that the routing scheme may include an amended ordered list of routing paths, and the requested transaction may be routed through the computer network according to the amended ordered list of routing paths.

According to some embodiments, one or more preference weights may correspond to one or more parameters, that may be selected from a group that may include: a feature vector (FV) parameter; a group characteristic (GC) parameter; a cost metric parameter; an expected revenue; and a transaction timeframe.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device, according to some embodiments of the invention;

FIG. 2 is a block diagram of a transaction routing system, according to some embodiments of the invention;

FIG. 3A and FIG. 3B are block diagrams, presenting two different examples for routing of transactions through nodes of a computer network, according to some embodiments of the invention;

FIG. 4 is a block diagram of a transaction routing system, according to some embodiments of the invention;

FIG. 5 is a block diagram, depicting an exemplary implementation of a neural network according to some embodiments of the invention;

FIG. 6 is a flow diagram, depicting a method of routing transactions through a computer network according to some embodiments of the invention;

FIG. 7 is a block diagram depicting a transaction routing system, according to some embodiments of the invention; and

FIG. 8 is a flow diagram depicting a method of routing transactions through a computer network according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

According to some embodiments, methods and systems are provided for routing transactions in a computer network. The method may include: receiving a request to route a transaction between two nodes of the computer network, each node connected via a link; automatically determining at least one characteristic and/or type of the requested transaction; and selection of an optimal route from a plurality of available routes for the requested transaction, in accordance with the determined characteristic and/or type and in accordance with available resources of the computer network to route data between the two nodes. In some embodiments, the calculated at least one route includes at least one node other than the two nodes.

The following Table 1 includes a list of terms used throughout this document, alongside respective definitions of the terms, for the reader's convenience:

TABLE 1

| | |
|---|---|
| Node | The term ‘Node’ may be used herein to refer to a computerized |
| | system, used for processing and/or routing transactions within a |
| | network of nodes. Nodes may include, for example: an individual |
| | computer, a server in an organization and a site operated by an |
| | organization (e.g. a data center or a server farm operated by an |
| | organization). For example, in Monetary Exchange (ME) |
| | transactions, nodes may include a server in a banking system, a |
| | computer of a paying-card issuer, etc. |
| Transaction | The term ‘transaction’ may be used herein to refer to |
| | communication of data between a source node and a destination |
| | node of a computer network. |
| | According to some embodiments, transactions may include a single, |
| | one-way transfer of data between the source node and the |
| | destination node. For example: a first server may propagate at least |
| | one data file to a second server as a payload within a transaction. |
| | Alternately, transactions may include a plurality of data transfers |
| | between the source node and the destination node. For example, a |
| | transaction may be or may include a monetary exchange between |
| | two institutions (such as banks), operating computer servers and |
| | computer equipment, where in order to carry out the transaction |
| | data needs to be transferred between the servers and other computer |
| | equipment operated by the institutions. |
| Transaction | The term ‘Payload’ may be used herein to refer to at least one |
| payload | content of a transaction that may be sent from the source node to |
| | the destination node. Payloads may include, for example. |
| | information included within the transaction (e.g. parameters of a |
| | financial transaction, such as a sum and a currency of a monetary |
| | exchange), a data file sent over the transaction, etc. |
| Transaction | The term “Transaction request” may be used herein to refer to a |
| request | request placed by a user, for a transaction between a source node |
| | and a destination node of a computer network. For example, a user |
| | may initiate a request to perform a monetary exchange transaction, |
| | between a source node (e.g. a server of a first bank) and a |
| | destination node (e.g. a server of a second bank). |
| User | The term ‘User’ may be used herein to refer to an individual or an |
| | organization that places at least one transaction request. According |
| | to some embodiments, the user may be associated with a profile, |
| | including at least one user preference, and data pertaining to |
| | previous transaction requests placed by the user. |
| Transaction | The term “Feature Vector” (FV) may be used herein to refer to a |
| feature vector | data structure, including a plurality of parameters associated with a |
| (FV) | transaction request. |
| | For example, transactions may be characterized by parameters such |
| | as: a payload type, a data transfer protocol, an identification (e.g., |
| | an IP address) of a source node, an identification (e.g., an IP |
| | address) of a destination node, etc. The FV may include at least one |
| | of these parameters in a data structure for further processing. |
| Transaction | The term “Transaction cluster” may be used herein to refer to an |
| cluster | aggregation of transactions according to transaction FVs. |
| | Transaction clusters may, for example, be obtained by inputting a |
| | plurality of FVs, each associated with a specific transaction request, |
| | to an unsupervised clustering model. Embodiments may |
| | subsequently associate at least one other (e.g. new) requested |
| | transaction to one cluster of the clustering model, as known to |
| | persons skilled in the art. |
| Group | The term “Group characteristics” may be used herein to refer to at |
| Characteristics | least one characteristic of a group of transactions. |
| (GCs) | Pertaining to the example of monetary exchange transactions, GCs |
| | may include for example availability of computational resources, |
| | an expected servicing time, a fraud propensity or likelihood, a |
| | decline propensity, a chargeback propensity, a probability of |
| | transaction success, a probability of transaction failure, etc. |
| | According to some embodiments, at least one GC may be attributed |
| | to at least one transaction cluster. For example, a processor may |
| | analyze the servicing time of all transactions within a transaction |
| | cluster and may attribute these transactions as having a long |
| | expected servicing time. |
| Routing path | The term “Routing path” may be used herein to refer to a path |
| | through nodes and links of the computer network, specified by the |
| | system for propagation of a transaction between a source node and |
| | a target or destination node of a computer network. |
| | Embodiments may include identifying a plurality of available |
| | routing paths for propagation of a transaction between a source |
| | node and a target or destination node of a computer network, as |
| | known to persons skilled in the art of computer networks. |
| Cost metrics | The term “Cost metrics” may be used herein to refer to a set of |
| | metrics that may be used to evaluate different available routing |
| | paths, to select an optimal routing path. |
| | Pertaining to the example of ME transactions, cost metrics may |
| | include at least one of for example a transaction fee per at least one |
| | available route, currency conversion spread and markup per the at |
| | least one available route, and a Net Present Value (NPV) per at least |
| | one available route, and a cancellation fee per at least one available |
| | route. |
| Transaction | The term “Transaction parameters” may be used herein to refer to |
| parameters | one or more data elements associated with a parameter or |
| | characteristic of a transaction. |
| | Pertaining to the example of ME transactions, transaction |
| | parameters may include for example one or more of: an FV (e.g., |
| | an identification (e.g., an IP address) of a source node, an |
| | identification (e.g., an IP address) of a destination node, etc.) a GC |
| | (e.g., a probability of transaction success) and a cost metric (e.g., a |
| | cost of the ME transaction, a cost for cancellation of the ME |
| | transaction, and the like). |

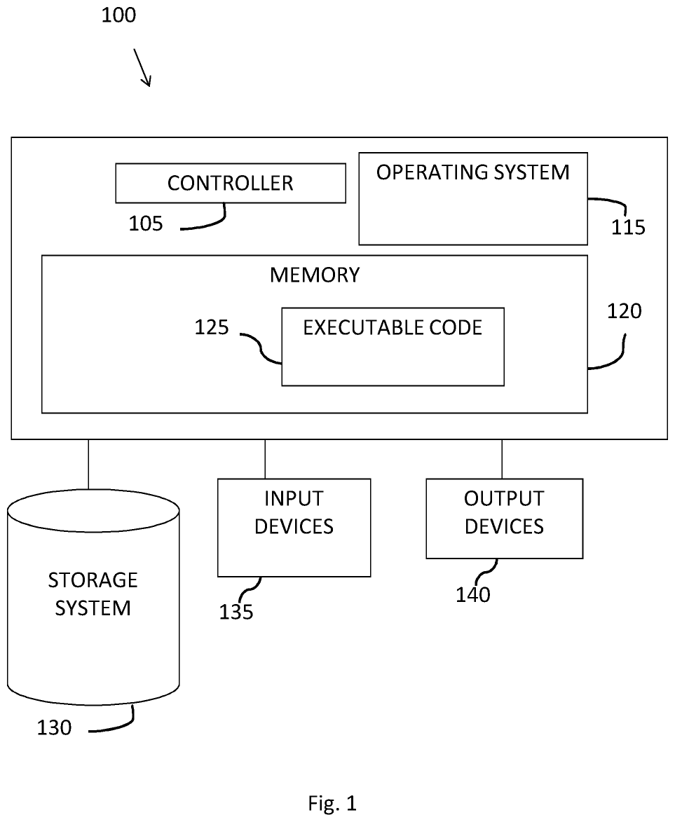

Reference is made to FIG. 1, which shows a block diagram of an exemplary computing device, according to some embodiments of the invention. A device 100 may include a controller 105 that may be, for example, a central processing unit processor (CPU), a chip or any suitable computing or computational device, an operating system 115, a memory 120, executable code 125, a storage system 130 that may include input devices 135 and output devices 140. Controller 105 (or one or more controllers or processors, possibly across multiple units or devices) may be configured to carry out methods described herein, and/or to execute or act as the various modules, units, etc. More than one computing device 100 may be included in, and one or more computing devices 100 may act as the components of, a system according to embodiments of the invention.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or tasks or enabling software programs or other modules or units to communicate. Operating system 115 may be a commercial operating system. It will be noted that an operating system 115 may be an optional component, e.g., in some embodiments, a system may include a computing device that does not require or include an operating system 115. For example, a computer system may be, or may include, a microcontroller, an application specific circuit (ASIC), a field programmable array (FPGA) and/or system on a chip (SOC) that may be used without an operating system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein.

Storage system 130 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Content may be stored in storage system 130 and may be loaded from storage system 130 into memory 120 where it may be processed by controller 105. In some embodiments, some of the components shown in FIG. 1 may be omitted. For example, memory 120 may be a non-volatile memory having the storage capacity of storage system 130. Accordingly, although shown as a separate component, storage system 130 may be embedded or included in memory 120.

Input devices 135 may be or may include any suitable input devices, components or systems, e.g., a detachable keyboard or keypad, a mouse and the like. Output devices 140 may include one or more (possibly detachable) displays or monitors, speakers and/or any other suitable output devices. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140. It will be recognized that any suitable number of input devices 135 and output device 140 may be operatively connected to computing device 100 as shown by blocks 135 and 140. For example, input devices 135 and output devices 140 may be used by a technician or engineer in order to connect to a computing device 100, update software and the like. Input and/or output devices or components 135 and 140 may be adapted to interface or communicate.

Embodiments of the invention may include a computer readable medium in transitory or non-transitory form that may include instructions, e.g., computer-executable instructions, which, when executed by a processor or controller, cause the processor or controller to carry out methods disclosed herein. For example, embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 120, computer-executable instructions such as executable code 125 and a controller such as controller 105.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of chips, FPGAs or SOCs, a plurality of computer or network devices, or any other suitable computing device. For example, a system as described herein may include one or more devices such as the computing device 100.

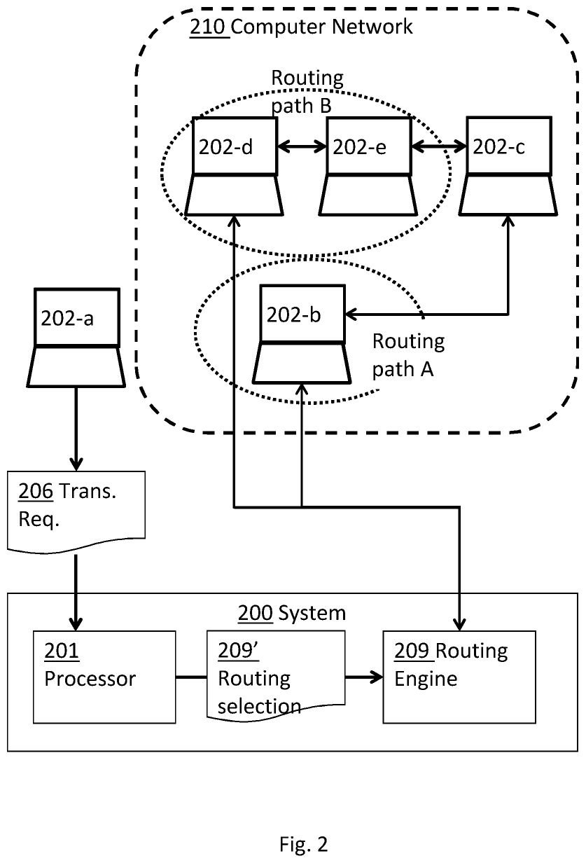

Reference is made to FIG. 2 which is a block diagram, depicting a non-limiting example of the function of a transaction routing system 200, according to some embodiments of the invention. The direction of arrows in FIG. 2 may indicate the direction of information flow in some embodiments. Of course, other information may flow in ways not according to the depicted arrows.

System 200 may include at least one processor 201 (such as controller 105 of FIG. 1) in communication (e.g., via a dedicated communication module) with at least one computing node (e.g. element 202-a). Processor 201 is shown for simplicity, and may include or be embodied in more than one computing device, computer, etc. Thus, reference below to processor 201 performing certain functions may in some embodiments mean that multiple computing systems perform the function if appropriate.

According to some embodiments, system 200 may be centrally placed, to control routing of a transaction over network 210 from a single location. For example, system 200 may be implemented as an online server, communicatively connected (e.g. through secure internet connection) to computing node 202-a. Alternately, system 200 may be directly linked to at least one of node 202 (e.g. 202-a).

In yet another embodiment, system 200 may be implemented as a plurality of computational devices (e.g. element 100 of FIG. 1) and may be distributed among a plurality of locations. System 200 may include any duplication of some or all of the components depicted in FIG. 2. System 200 may be communicatively connected to a plurality of computational nodes (e.g. 202-a) to control routing of transactions over network 210 from a plurality of locations.

In some embodiments, computing nodes 202-a thru 202-e of computer network 210 may be interconnected, where each node may be connected to at least one other node via one or more links, to enable communication there between. In some embodiments, each computing node 202 may include memory and a dedicated operating system (e.g., similar to memory 120 and a dedicated operating system 115 as shown in FIG. 1).

As shown in FIG. 2, system 200 may receive a transaction request 206, to perform a transaction between a source node (e.g., 202-a) and a destination node (e.g.: 202-c). According to some embodiments, processor 201 may be configured to: analyze transaction request 206 (as explained further below); identify one or more available routing paths (e.g. route A and route B) that connect the source node and destination node; and select an optimal routing path (e.g. route A) for the requested transaction.

According to some embodiments, processor 201 may be configured to produce a routing path selection 209′, associating the requested transaction with the selected routing path. System 200 may include a routing engine 209, configured to receive routing path selection 209′ from processor 201, and determine or dictate the routing of requested transaction 206 in computer network 210 between the source node (e.g.: 202-a) and destination node (e.g.: 202-c) according to the routing path selection.

As known to persons skilled in the art of computer networking, dictation of specific routes for transactions over computer networks is common practice. In some embodiments, routing engine 209 may determine or dictate a specific route for transaction by utilizing low-level functionality of an operating system (e.g. element 115 of FIG. 1) of a source node (e.g. 202-a) to transmit the transaction over a specific network interface (e.g. over a specific communication port) to an IP address and port of a destination node (e.g. 202-c). For example, routing engine 209 may include specific metadata in the transaction (e.g. wrap a transaction payload in a Transmission Control Protocol (TCP) packet) and send the packet over a specific pre-established connection (e.g. TCP connection) to ensure that a payload of the transaction is delivered by lower-tier infrastructure to the correct destination node (e.g. 202-c), via a selected route.

Embodiments of the present invention present an improvement to routing algorithms known in the art, by enhancing the selection of an optimal routing path from a plurality of available routes. Routing algorithms known in the art are normally configured to select a routing path according to a predefined set, consisting a handful of preselected parameters (e.g. a source node address, a destination node address, a type of a service and a desired Quality-of-Service (QoS)). Embodiments of the present invention may employ algorithms of artificial intelligence (AI) to dynamically select optimal routing paths for requested transactions, according to constantly evolving ML models that may not be limited to any set of input parameters, or to any value of a specific input parameter, as explained further below.

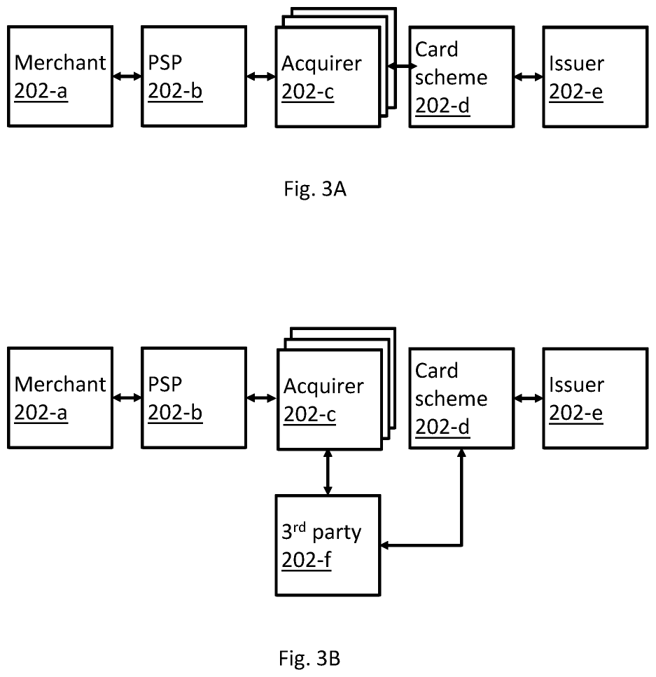

Reference is made to FIG. 3A and FIG. 3B, which are block diagrams presenting two different examples for routing ME transactions through nodes of a computer network, according to parameters of the payload, e.g. financial transaction. In each of the depicted examples, a merchant may require settling a financial transaction through transfer of a monetary value, between the merchant's bank account, handled by node 202-c in an acquirer bank and a consumer's bank account handled by node 202-e in an issuer bank.

The examples depicted in FIG. 3A and FIG. 3B may differ in the selected route due to different parameters of the financial transaction, including for example: a method of payment, predefined security preferences as dictated by the merchant, a maximal NPV of the financial transaction (e.g. due to delays in currency transfer imposed by policies of a payment card issuer), etc.

FIG. 3A depicts a non-limiting example of an e-commerce transaction involving a payment card (e.g. a credit card or a debit card), in which the merchant has dictated a high level of security. For example: the merchant may have preselected to verify the authenticity of the paying card's Card Verification Code (CVC), perform 3D Secure authentication, perform address verification, etc. The transaction may therefore be routed according to the routing path, as described below.

From the merchant's computer 202-a, the transaction may be routed to a payment service provider (PSP) 202-b, which offers shops online services for accepting electronic payments by a variety of payment methods, as known to persons skilled in the art of online banking methods.

From PSP 202-b, the transaction may be routed to the acquirer node 202-c, where, for example, the merchant's bank account is handled. In some embodiments, the merchant may be associated with a plurality of acquirer nodes 202-c and may select to route the transaction via one of the acquirer nodes 202-c for example to maximize profit from a financial transaction.

For example: the paying-card holder may have his account managed in US dollars. The merchant may be associated with two bank accounts, (e.g. two respective acquirer nodes 202-c), in which the merchant's accounts are managed in Euros. Embodiments may enable the merchant to select a route that includes an acquirer node 202-c that provides the best US Dollar to Euro currency exchange rate.

In another example, a card holder may perform payment through various methods, including for example, a merchant's website or a telephone order (e.g. a consumer may order pizza through a website, or by dictating the paying-card credentials through the phone). Banks may associate a different level of risk to each payment method and may charge a different percentage of commission per each financial transaction, according to the associated risk. Assuming the merchant is associated with two bank accounts, (e.g. two respective acquirer nodes 202-c), where a first bank imposes lower commission for a first payment method, and a second bank imposes lower commission for a second payment method. Embodiments may enable the merchant to route the transaction through an acquirer node 202-c according to the payment method, to incur the minimal commission for each transaction.

From acquirer node 202-c, the transaction may be routed to a card scheme 202-d, which, as known to persons familiar in the art of online banking, is a payment computer network linked to the payment card, and which facilitates the financial transaction, including for example transfer of funds, production of invoices, conversion of currency, etc., between the acquirer bank (associated with the merchant) and the issuer bank (associated with the consumer). Card scheme 202-d may be configured to verify the authenticity of the paying card as required by the merchant (e.g. verify the authenticity of the paying card's Card Verification Code (CVC), perform 3D Secure authentication, perform address verification, etc.).

From card scheme 202-d, the transaction may be routed to issuer node 202-e, in which the consumer's bank account may be handled, handle the payment.

From issuer node 202-e, the transaction may follow in the track of the routing path all the way back to merchant node 202-a, to confirm the payment.

FIG. 3B depicts a non-limiting example for a card-on-file ME transaction, in which a consumer's credit card credentials may be stored within a database or a secure server accessible by the merchant, (e.g. in the case of an autopayment of recurring utilities bills, or a recurring purchase in an online store). As known to persons skilled in the art of online banking, card-on-file transaction do not require the transfer paying-card credentials from the merchant to the acquirer 202-c. Instead, a token indicative of the paying-card's number may be stored on merchant 202-a, and a table associating the token with the paying-card number may be stored on a third-party node 202-f.

As shown in FIG. 3B, PSP 202-b addresses 202-f and requests to translate the token to a paying-card number, and then forwards the number to acquirer 202-c, to authorize payment.

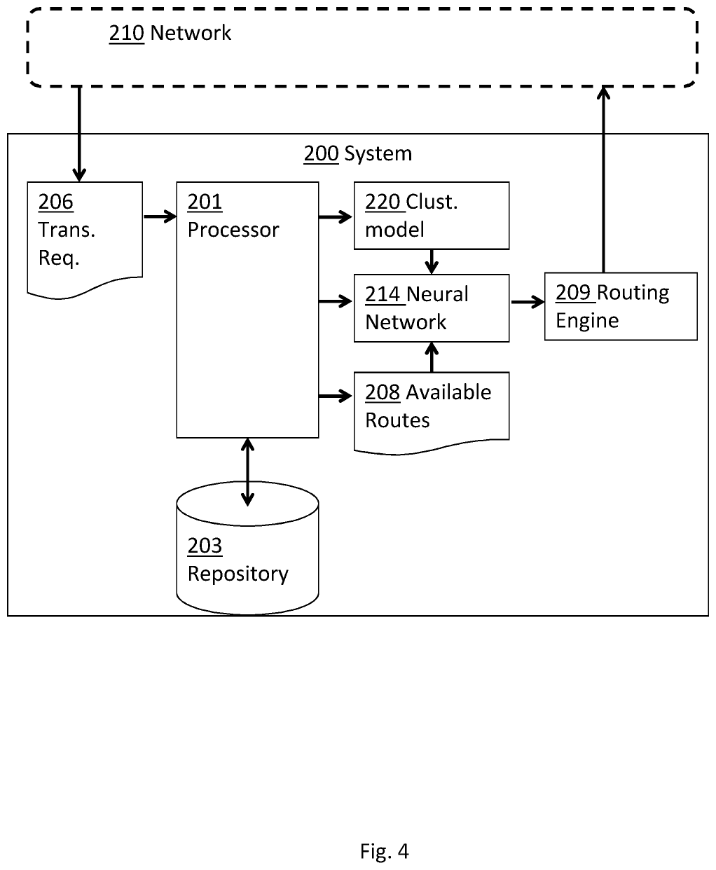

Reference is made to FIG. 4 which shows a block diagram of a transaction routing system 200, according to some embodiments of the invention. The direction of arrows in FIG. 4 may indicate the direction of information flow.

System 200 may include at least one repository 203, in communication with the at least one processor 201. Repository 203 may be configured to store information relating to at least one transaction, at least one user and at least one route, including for example: Transaction FV, Transaction GC, cost metrics associated with specific routes, and User preferences. In some embodiments, routing of transactions between the computing nodes 202 of computer network 210 may be optimized in accordance with the data stored in repository 203, as explained further below.

According to some embodiments, processor 201 may be configured to receive at least one transaction request, including one or more data elements, to route a transaction between two nodes of the computer network. For example, processor 201 may receive an ME transaction requests, associated with a paying card (e.g. a credit card or debit card). The ME request may include data pertaining to parameters such as:
Transaction sum;
Transaction currency;
Transaction date and time (e.g.: in Coordinated Universal Time (UTC) format);
Bank Identification Number (BIN) of the paying card's issuing bank;
Country of the paying card's issuing bank;
Paying card's product code;
Paying card's Personal Identification Number (PIN);
Paying card's expiry date
Paying card's sequence number
Destination terminal (e.g. data pertaining to a terminal in a banking computational system, which is configured to maintain the payment recipient's account);
Target merchant (e.g. data pertaining to the payment recipient);
Merchant category code (MCC) of the payment recipient;
Transaction type (e.g.: purchase, refund, reversal, authorization, account validation, capture, fund transfer);
Transaction source (e.g. physical terminal, mail order, telephone order, electronic commerce and stored credentials);
Transaction subtype (e.g.: magnetic stripe, magnetic stripe fallback, manual key-in, chip, contactless and Interactive Voice Response (IVR)); and
Transaction authentication (e.g.: no cardholder verification, signature, offline PIN, online PIN, no online authentication, attempted 3D secure, authenticated 3D secure).

Other or different information may be used, and different transactions may be processed and routed.

According to some embodiments, processor 201 may extract from the transaction request an FV, including at least one feature associated with the requested transaction. For example, the FV may include an ordered list of items, where each item represents at least one data element of the received transaction request.

Examples for representation of data element of the received transaction request as items in an FV may include:

Destination terminals may be represented by their geographic location (e.g. the destination terminal's geographical longitude and latitude as stored in a terminal database).
The Transaction type, source, subtype and authentication may be represented by mapping them into a binary indicator vector, where each position of the vector may correspond to a specific sort of transaction type/source/subtype/authentication and may be assigned a ‘1’ value if the transaction belongs to a specific type/source/subtype/authentication and ‘0’ otherwise.

According to some embodiments, system 200 may include a clustering model 220, consisting of a plurality of transaction clusters. Clustering model 220 may be configured to receive a plurality of feature vectors (FVs), each associated with a respective transaction request, and each including at least one feature associated with the respective transaction request. Clustering model 220 may cluster the plurality of transaction requests to at least one transaction cluster, according to the at least one feature.

As known to persons skilled in the art of AI, the outcome of non-supervised clustering may not be predictable. However, clusters may be expected to group together items of similar features. Pertaining to the example of ME transactions, clusters may evolve to group together e-commerce purchase transactions made with payment cards of a particular issuer, transactions involving similar amounts of money, transactions involving specific merchants, etc.

According to some embodiments, clustering module 220 may be implemented as a software module, and may be executed, for example, by processor 201. Alternately, clustering module 220 may be implemented on a computational system that is separate from processor 201 and may include a proprietary processor communicatively connected to processor 201.

According to some embodiments, clustering module 220 may apply an unsupervised, machine learning expectation-maximization (EM) algorithm to the plurality of received FVs, to produce a set of transaction clusters, where each of the plurality of received FVs is associated with one transaction cluster, as known to persons skilled in the art of machine learning.

According to some embodiments, producing a set of transaction clusters by clustering module 220 may include: (a) assuming an initial number of K multi-variant gaussian distributions of data; (b) selecting K initial values (e.g. mean and standard-deviation values) for the respective K multi-variant gaussian distributions; (c) calculating the expected value of log-likelihood function (e.g. calculating the probability that an FV belongs to a specific transaction cluster, given the K mean and standard-deviation values); and (d) adjusting the K mean and standard-deviation values to obtain maximum-likelihood. According to some embodiments, steps (c) and (d) may be repeated iteratively, until the algorithm converges, in the sense that the adjustment of the K values does not exceed a predefined threshold between two consecutive iterations.

According to some embodiments, processor 201 may be configured to extract an FV from at least one incoming requested transaction and associate the at least one requested transaction with a transaction cluster in the clustering model according to extracted FV. For example, the extracted FV may be associated with a transaction cluster according to a maximum-likelihood best fit algorithm, as known to persons skilled in the art of machine-learning.

According to some embodiments, processor 201 may be configured to calculate at least one GC for each transaction cluster and attribute the calculated GC to at least one received request, based on the association of the requested transaction with the transaction cluster.

For example, in the case of ME transactions, the GC may be selected from a list consisting of decline propensity, fraud propensity, chargeback propensity and expected service time, as elaborated further below. Clusters of ME transactions may be attributed an expected service time, and consequently incoming transaction requests that are associated with specific transaction clusters may also be attributed the same expected service time.

According to some embodiments, processor 201 may be configured to: (a) receive at least one incoming requested transaction, including a source node and a destination node; (b) produce a list, including a plurality of available routes for communicating the requested transaction in accordance with available resources of computer network 210 (e.g. by any dynamic routing protocol such as a “next-hop” forwarding protocol, as known to persons skilled in the art of computer networks); and (c) calculate at least one cost metric (e.g.: an expected latency) for each route between the source node and destination node in the computer network.

According to some embodiments, system 200 may include at least one neural network module 214, configured to produce at least one routing path selection (e.g. element 209′ of FIG. 2), associating at least one transaction with a routing path between a source node and a destination node of the computer network.

Embodiments may include a plurality of neural network modules 214, each dedicated to one respective cluster of clustering model 220, and each cluster of the clustering model associated with a one respective neural network module. Each neural network module 214, may be configured to select at least one routing path for at least one specific transaction associated with the respective cluster. This dedication of neural network modules 214 to respective clusters of clustering model 220 may facilitate efficient production of routing path selections for new transaction requests, according to training of the neural network modules on data derived from similar transactions.

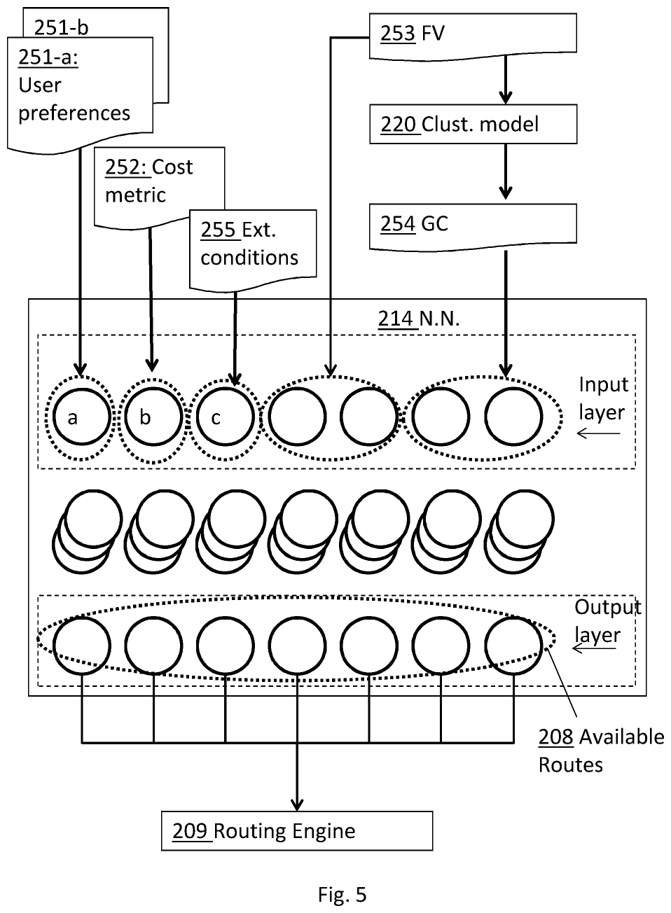

Reference is now made to FIG. 5, which is a block diagram depicting an exemplary implementation of neural network 214, including a plurality of network nodes (e.g. a, b, c etc.) according to some embodiments. In one embodiment a neural network may include an input layer of neurons, and an output layer of neurons, respectively configured to accept input and produce output, as known to persons skilled in the art of neural networks. The neural network may be a deep-learning neural network and may further include at least one internal, hidden layer of neurons, intricately connected among themselves (not shown in FIG. 5), as also known to persons skilled in the art of neural networks. Other structures of neural networks may be used.

According to some embodiments, neural network 214 may be configured to receive at least one of: a list that may including a plurality of available routing paths 208 from processor 201; at least one cost metric 252 associated with each available route; at least one requested transaction's FV 253; the at least one requested transaction's GC 254; at least one user preference 251; and at least one external condition 255 (e.g. the time of day). Neural network 214 may be configured to generate at least one routing path selection according to the received input, to select at least one routing path for the at least one requested transaction from the plurality of available routing paths. As shown in the embodiment depicted in FIG. 5, user preference 251, cost metric 252, FV 253, GC 254 and external condition 255 may be provided to neural network 214 at an input layer, as known to persons skilled in the art of machine learning.

As shown in the embodiment depicted in FIG. 5, neural network 214 may have a plurality of nodes at an output layer. According to some embodiments, neural network 214 may implicitly contain routing selections for each possible transaction, encoded as internal states of neurons of the neural network 214. For example, neural network 214 may be trained to emit or produce a binary selection vector on an output layer of neural nodes. Each node may be associated with one available route, as calculated by processor 201. The value of the binary selection vector may be indicative of a selected routing path. For example, neural network 214 may emit a selection vector with the value ‘001’ on neural nodes of the output layer that may signify a selection of a first routing path in a list of routing paths 208, whereas a selection vector with the value ‘011’ may signify a selection of a third routing path in the list of routing paths.

According to some embodiments, neural network 214 may be configured to generate at least one routing path selection of an optimal routing path according to at least one cost metric 252.

For example: A user may purchase goods online through a website. The purchase may be conducted as an ME transaction between a source node (e.g. a banking server that handles the user's bank account) and a destination node (e.g. the merchant's destination terminal, which handles the merchant's bank account). The purchase may require at least one conversion of currency, and the user may prefer to route a transaction through a routing path that would minimize currency conversion costs. Processor 201 may calculate a plurality of available routing paths for the requested ME transaction (e.g. routes that pass via a plurality of banking servers, each having different currency conversion spread and markup rates) and calculate cost metrics (e.g. the currency conversion spread and markup) per each available transaction routing path. Neural network 214 may select a route that minimizes currency conversion costs according to these cost metrics.

The term ‘weight’ may be used herein in relation to one or more specific transaction parameters (e.g., cost metrics, FV and GC) to refer to a level of importance that may be attributed (e.g., by a user's preference) to the respective transaction parameters. System 200 may be configured to choose an optimal routing path according to the values of transaction parameters and respective attributed weights.

For example, system 200 may be configured to receive a first preference weight (e.g., PW1) for a first transaction parameter, and a second preference weight (e.g., PW2) for a second transaction parameter. System 200 may further be configured to obtain:

a first value (e.g., VA1) of the first transaction parameter (e.g., a cost metric) corresponding to a routing path;

a second value (e.g., VB1) of the second transaction parameter corresponding to the first routing path;

a third value (e.g., VA2) of the first transaction parameter corresponding to a second routing path; and

a fourth value (e.g., VB2) of the second transaction parameter corresponding to the second routing path.

One weight or preference may correspond to multiple specific instances of a certain value. System 200 may be configured to subsequently choose an optimal routing path according to the products of corresponding preference weights and parameter values. For example:

if [(PW1*VA1)+(PW2*VB1)]>[(PW1*VA2)+(PW2*VB2)] then system 200 may choose to route the transaction via the first routing path, and

if [(PW1*VA1)+(PW2*VB1)]<[(PW1*VA2)+(PW2*VB2)] then system 200 may choose to route the transaction via the second routing path.

In some embodiments, system 200 may be configured to select an optimal routing path according to a weighted plurality of transaction parameters (e.g., cost metrics).

Pertaining to the example above: the user may require, in addition to a minimal currency conversion cost, that the transaction's service time (e.g.: the period between sending an order to transfer funds and receiving a confirmation of payment) would be minimal. The user may provide a weight for each preference (e.g. minimal currency conversion cost and minimal service time), to determine an optimal routing path according to the plurality of predefined cost metrics.

In some embodiments, processor 201 may be configured to dynamically calculate a Net Present Value (NPV) cost metric per each available routing path. For example, consider two available routing paths for an ME transaction, where the first path includes at least a first intermediary node that is a banking server in a first country and the second path includes at least a second intermediary node that is a banking server in a second country. Assuming that the first and second banking servers operate at different times and work days, the decision of a routing path may incur considerable delay on one path in relation to the other. This relative delay of the ME transaction may, for example, affect the nominal amount and the NPV of the financial settlement.

In another example of an ME transaction, processor 201 may be configured to: determine a delay, in days (d), by which money will be released to a merchant according to each available routing path; obtain at least one interest rate (i) associated with at least one available routing path; and calculate a present value (PV) loss value for the settlement currency used over each specific route, one example being expressed by Eq. 1 below:

PVLoss=Amount×(1+i)^{d} Eq. 1

### Where:

‘PV_{Loss}’ may represent the PV loss value;

‘Amount’ may represent the original monetary value of the ME transaction;

‘d’ may represent the delay (e.g., in days); and

‘i’ may represent the respective interest.

In some embodiments, processor 201 may be configured to calculate a cost metric relating to transaction-fees per at least one available route. For example, in ME transactions, processor 201 may calculate the transaction fees incurred by routing the transaction through a specific route-path, by taking into account, for example: (a) a paying card's interchange fee (e.g.: as dictated by its product code and its issuing bank country); (b) additional fees applicable for specific transaction types (e.g.: purchase, refund, reversal, authorization, account validation, capture, fund transfer); (c) discount rate percentage applicable for specific transaction types; and (d) fixed fee as applicable for the specific type of transaction. The transaction fee cost metric may be calculated, in one example as expressed below, in Eq. 2:

TransactionFee=interchange+AdditionalFees+(Amount×DiscountRatePercentage)+FixedFee Eq. 2

### Where:

‘TransactionFee’ may represent the calculated cost metric relating to a specific available routing path;

‘interchange’ may represent the paying card's interchange fee;

‘AdditionalFees’ may represent the additional fees applicable for specific transaction types;

‘Amount’ may represent the original monetary value of the ME transaction;

‘DiscountRatePercentage’ may represent the discount rate percentage applicable for specific transaction types; and

‘FixedFee’ may represent the fixed fee applicable for the specific type of transaction.

In another example regarding ME transactions, the cost metric may be one of a cancellation fee, which may be incurred on an owner of a credit card following cancellation of a purchase.

According to some embodiments, system 200 may include a routing engine 209, configured to receive at least one requested transaction from processor 201, and a respective routing path selection from neural network 214, and route the requested transaction through network 210 according to the respective routing path selection.

Pertaining to the ME transaction example above: routing engine 209 may receive a routing path selection, assigning an optimal routing path to a specific requested monetary transaction between the source node (e.g. a computer that handles the user's bank account) and the merchant's destination terminal (e.g. a banking server that handles the merchant's bank account). Routing engine 209 may use any type of routing protocol to facilitate or cause routing the requested transaction through network 210, as known in the art, including for example: The Interior Gateway Routing Protocol (IGRP), the Enhanced Interior Gateway Routing Protocol (EIGRP), the Routing Information Protocol (RIP), the Border Gateway Protocol (BGP) and the Exterior Gateway Protocol (EGP).

Routing engine 209 may employ any suitable routing protocol known to a person skilled in the art of computer networks, to route at least one communication between the source node and the destination node via the selected optimal routing path, including for example: a funds transfer message from the source node to the destination node, and a payment confirmation message from the destination node back to the source node. In some embodiments, routing engine 209 may dictate or control a specific route for transaction by utilizing low-level functionality of an operating system (e.g. element 115 of FIG. 1) of a source node to transmit the transaction over a specific network interface to an IP address and port (e.g. a TCP socket) of a destination node.

According to some embodiments, processor 201 may be configured to accumulate historic information regarding the status of transactions and may store the accumulated information in a storage device (e.g. repository 203 of FIG. 4). Processor 201 may calculate at least one GC for at least one transaction cluster of clustering model 220 according to the stored information and attribute the at least one calculated GC to at least one received transaction request, based on the association of the requested transaction with the transaction cluster. Neural network 214 may consequently determine an optimal routing path according the at least one calculated GC, thereby reducing processing power after initial training of clustering model 220.

Pertaining to the example of ME transactions, GC may be selected from a list including for example decline propensity, fraud propensity, chargeback propensity, transaction success probability, transaction failure probability, transaction dependent success probability, transaction dependent failure probability and expected service time.

For example, processor 201 may accumulate status data per each transaction, including information regarding whether the transaction has been declined P_{decline}, and may calculate the decline propensity of each transaction cluster as the ratio between the number of declined transactions (e.g., #{declined transactions}) and the total number of transactions (e.g., #{all transactions}), as expressed by one example below, in Eq. 3:

$${P}_{decline} = \frac{\# \{ declined transactions \}}{\# \{ all transactions \}} \qquad Eq . 3$$

In another example, processor 201 may accumulate status data per each transaction, including information regarding whether the transaction has been fraudulent, and may calculate the fraud propensity (e.g., P_{fraud}) of each transaction cluster as the ratio between the number of fraudulent transactions (e.g., as determined by an administrator and/or a security system, as known in the art) and the number of non-declined transactions, as expressed by one example below, in Eq. 4:

$${P}_{fraud} = \frac{\# \{ fraudulent transactions \}}{\# \{ all non \text{-} declined transactions \}} \qquad Eq . 4$$

### Where:

#{fraudulent transactions} may represent the number of fraudulent transactions; and

#{non-declined transactions} may represents the total number of non-declined transactions.

In another example, processor 201 may calculate the sum-weighted fraud propensity PW_{fraud} of each transaction cluster according to a ratio, as expressed by one example below, in Eq. 5:

$${PW}_{fraud} = \frac{\sum ( \{ fraudulent transactions \} * amount )}{\sum ( \{ non \text{-} declined transactions \} * amount )} \qquad Eq . 5$$

### Where:

‘amount’ may represent a monetary value of an ME transaction;

Σ({fraudulent transactions} *amount) may represent a weighted sum of all fraudulent transactions; and

Σ({non-declined transactions} *amount) may represent a weighted sum of all non-declined transactions.

In another example, processor 201 may calculate an overall probability of transaction success (e.g., without being denied and/or attributed to a fraudulent attempt) for each transaction cluster (e.g., through routing path A) as expressed, for example, by equation Eq. 6A:

$${P}_{success , A} = \frac{\begin{matrix}\# \{ all transactions \} - \# \{ declined transactions \} - \\ \# \{ fraudulent transactions \}\end{matrix}}{\# \{ all transactions \}} \qquad Eq . 6 A$$

### Where:

P_{success,A} may represent the overall probability of transaction success when being routed through routing path A;

#{transactions} may represent the total number of transactions routed through the respective routing path (e.g., path A);

#{declined transactions} may represent the number declined transactions routed through the respective routing path (e.g., path A);

#{fraudulent transactions} may represent the total number of transactions that have been routed through the respective routing path (e.g., path A), and that may have been determined as fraudulent.

In another example, processor 201 may calculate an overall probability of transaction failure for each transaction cluster (e.g., through routing path A), one example being expressed in equation Eq. 6B:

P_{failure,A}=(1−P_{success, A}) Eq. 6B

### Where:

P_{success,A} may represent the overall probability of transaction success when being routed through routing path A; and

P_{failure, A} may represent the probability of transaction failure for each transaction cluster (e.g., through routing path A).

In another example, processor 201 may accumulate information regarding conditions in which more than one attempt to route a requested transaction has taken place, to calculate a dependent success probability (e.g., when a first attempt, through routing path A has failed, and a second attempt, through path B has succeeded), one example being expressed by Equation 7A:

$${P}_{success B \vert failure A} = \\ [ \\ \# \{ {transactions}_{B \vert failure A} \} - \\ \# \{ declined {transactions}_{B \vert failure A} \} - \\ \# \{ fraudulent {transactions}_{B \vert failure A} \} \\ ] \\ / \# \{ {transactions}_{B \vert failure A} \} \qquad Eq . 7 A$$

### Where:

P_{success B|failure A} may represent the dependent probability of a successful routing attempt through routing path B, following a failure of a routing attempt through routing path A;

#{transactions B|failure A} may represent the total number of transaction attempts through routing path B following a failed routing attempt through routing path A;

#{declined transactions B|failure A} may represent the number of declined transaction attempts through routing path B following a failed routing attempt through routing path A; and

#{fraudulent transactions B|failure A} may represent the number of fraudulent transaction attempts through routing path B following a failed routing attempt through routing path A.

In yet another example, processor 201 may accumulate information regarding conditions in which more than one attempt to route a requested transaction has taken place, to calculate a dependent failure probability (e.g., when a first attempt, through routing path A has failed, and a second attempt, through path B has also failed), one example being expressed by Equation 7B:

P_{failure B|failure A}=(1−P_{success B|failure A}) Eq. 7B

### Where:

P_{failure B|failure A} may represent the dependent probability of a failed routing attempt through routing path B, following a failure of a routing attempt through routing path A; and

P_{success B|failure A} may represent the dependent probability of a successful routing attempt through routing path B, following a failure of a routing attempt through routing path A.

According to some embodiments, at least one GC may be attributed to at least one subset of the overall group of transactions. For example, processor 201 may analyze a subset of transactions which is characterized by at least one common denominator (e.g. a common destination node) and attribute all transactions within this subset with a common GC (e.g. as having a high decline propensity).

According to some embodiments, at least one combination of at least one user preference 251, at least one cost metric 252 and at least one GC 254 may affect a selection of an optimal routing path by the neural network.

Pertaining to the example of ME transactions, a user may be, for example an individual (e.g. a consumer, a merchant, a person trading online in an online stock market, and the like), or an organization or institution (e.g. a bank or another financial institution). Each such user may define at least one preference 251 according to their inherent needs and interests. For example: a user may define a first preference 251-a for an ME transaction to maximize the NPV and define a second preference 251-b for the ME transaction to be performed with minimal fraud propensity. The user may define a weight for each of preferences 251-a and 251-b (e.g., a preference weight), that may affect the selection of an optimal routing path. For example:

If the weighted value for preference 251-a is larger than that of preference 251-b, a route that provides maximal NPV may be selected.
If the weighted value for preference 251-a is smaller than that of preference 251-b, a route that provides minimal fraud propensity may be selected.

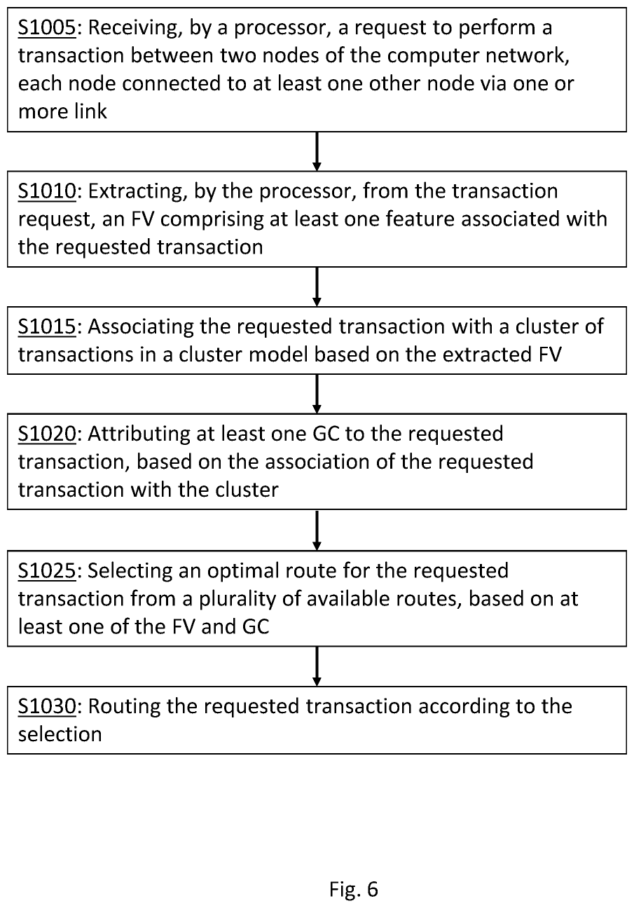

Reference is now made to FIG. 6, which is a flow diagram, depicting a method of routing transactions through a computer network according to some embodiments.

In step S1005, a processor may receive a request to perform a transaction between two nodes of a computer network, where each node may be connected to at least one other node via one or more links. For example, the requested transaction may be an ME transaction, meant to transfer funds between a first banking server and a second banking server.

In step S1010, the processor may extract from the transaction request, a feature vector (FV). The FV may include at least one feature associated with the requested transaction. In the example of the ME transaction above, the FV may include data pertaining to a type of the ME transaction (e.g.: purchase, refund, reversal, authorization, account validation, capture, fund transfer, etc.), a source node, a destination node, etc.

In step S1015, the processor may associate the requested transaction with a cluster of transactions in a clustering model based on the extracted FV. For example, the processor may implement a clustering module, that may include a plurality of transaction clusters, clustered according to at least one FV feature. The clustering module may be configured to associate the requested transaction with a transaction cluster by a best fit maximum likelihood algorithm.

In step S1020, the processor may attribute at least one GC (e.g.: fraud propensity) to the requested transaction, based on the association of the requested transaction with the cluster.

In step S1025, the processor may select an optimal route for the requested transaction from a plurality of available routes, based on at least one of the FV and GC.

In step S1030, the processor may route the requested transaction according to the selection. For example, the processor may emit a routing path selection, associating the requested transaction with a selected routing path within the computer network. According to some embodiments, a routing engine may receive the routing path selection from the processor and may dictate or control the routing of the requested transaction via the selected routing path.

In some embodiments, system 200 may be configured to select an optimal routing path according to a weighted combination of elements, including cost metrics and/or GC.

For example, a user may want to perform an ME transaction that may incur minimal currency conversion cost and where the transactions service time (e.g., the period between sending an order to transfer funds and receiving a confirmation of payment) would be minimal. The user may provide (e.g., via input device 135 of FIG. 1) a weight for each preference (e.g., a preference weight). For example, the user may provide a first preference weight for a cost metric element (e.g., minimal currency conversion cost) and a second preference weight for a GC element (e.g., minimal service time). NN 214 may be configured to determine an optimal routing path according to the weighted combination of elements (e.g., one or more cost metrics 252 such as minimal currency conversion cost and/or one or more GC elements 254, such as minimal service time).

In another example, a user may want to perform an ME transaction that may incur minimal transaction fees, and that may have a maximal probability for being successfully completed (e.g., have minimal fraud and/or decline propensities). The user may provide (e.g., via input device 135 of FIG. 1) a weight for each preference. For example, the user may provide a first preference weight for a cost metric element (e.g., minimal transaction fees) and a second preference weight for a GC element (e.g., minimal fraud and/or decline propensities). NN 214 may be configured to determine an optimal routing path according to the weighted combination of elements (e.g., one or more cost metrics 252 such as minimal transaction fees and/or one or more GC elements 254, such as fraud and/or decline propensities).

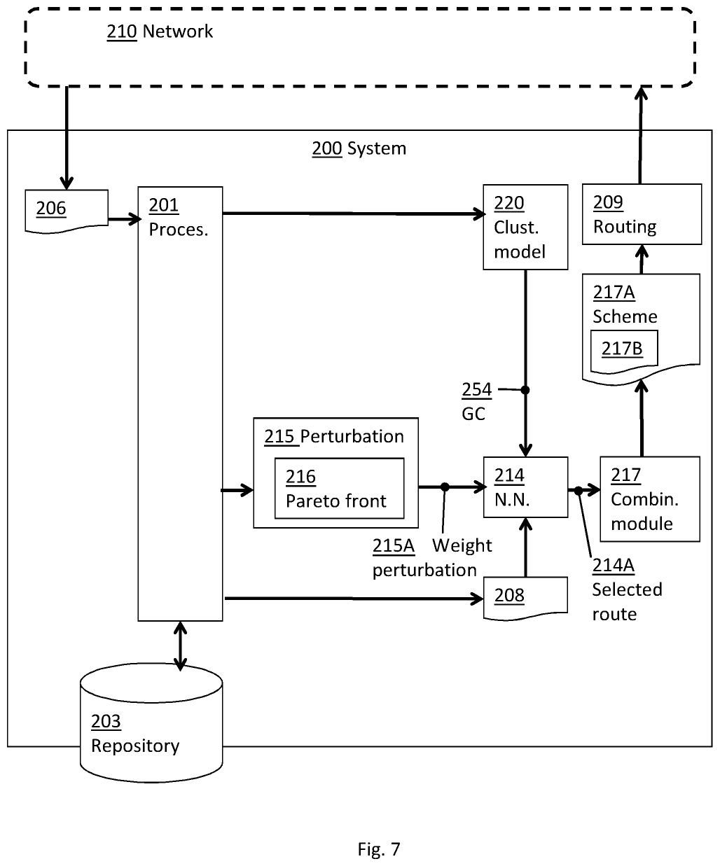

Reference is now made to FIG. 7, which shows a block diagram of a transaction routing system 200, according to some embodiments of the invention. System 200 may be configured to receive a transaction request 206 to route a transaction between a source node and destination node of a computer network 210, where each node may be connected to at least one other node via one or more links, as known in the art. System 200 may be configured to produce a routing scheme 217A that may include one or more routing paths and/or combinations of routing paths, that may be for example ordered in an ordered list. System 200 may route the requested transaction according to the ordered list 217B of routing paths. As elaborated herein, the ordering of routing paths and/or combinations of routing paths in routing scheme 217A may facilitate dynamic and optimal routing of requested transaction 206 through network 210 according to predefined preferences.

According to some embodiments, system 200 may identify a plurality of available routing paths, for routing, sending or propagating the transaction between the source node and destination node based on the transaction request. For example, processor 201 may be configured to identify one or more routing paths, each including one or more computing devices that may be communicatively connected or linked by any type of computer communication and may connect the source node and destination node.

System 200 may obtain or receive one or more transaction parameters for each available routing path, based on the transaction request, as explained herein. For example, a user may want to transfer or route an ME transaction through network 210, from a source node to a destination node. System 200 may obtain one or more transaction parameters (e.g., cost metrics, FV, GC) for each of the plurality of available routing paths. The one or more transaction parameters may include, for example, one or more of: an FV parameter (e.g., an identity of a source node, an identity of a destination node, etc.), a GC parameter (e.g., a probability of transaction success) and a cost metric parameter (e.g., a cost of the ME transaction, a cost for cancellation of the ME transaction, and the like).

According to some embodiments, system 200 may receive a set of preference weights that may include one or more preference weights (e.g., 251-A, 251-B of FIG. 5), where each preference weight of the received set of preference weights corresponds to a transaction parameter. The preference weights may correspond to or indicate a user's preference or valuation in regard to one or more transaction parameters (e.g., a minimal service time, a minimal fraud propensity, and the like).

For example, a user may perform an ME transaction, such as a credit card, online purchase from an online web site of a specific merchant. The user may value or prefer a first transaction parameter over a second transaction parameter. For example, the user may value a GC parameter (e.g., a probability of transaction success) of the ME transaction more than a cost metric parameter (e.g., a currency conversion cost). The user may thus input (e.g., via element 135 of FIG. 1) a first set of preference weights, including a first preference weight value 251-A, associated with the GC (e.g., the probability of success), and a second preference weight value 251-B, associated with the cost metric (e.g., the currency conversion cost), where the first preference weight value 251-A may be larger than the second preference weight value 251-B.

According to some embodiments, NN 214 may be configured to select or choose one or more routing paths from the plurality of available routing paths, based on the one or more transaction parameters and respective preference weights.

For example, NN 214 may receive at least one of:

a list including a plurality of available routing paths 208 from processor 201;
at least one transaction parameter (including for example: a cost metric 252 associated with each available route; at least one requested transaction's FV 253; the at least one requested transactions GC 254);
a set of preference weights that may include one or more user preference weight values 251, where each user preference 251 may correspond to a respective transaction parameter; and at least one external condition 255 (e.g. the time of day).

Neural network 214 may generate at least one routing path selection according to the received input, to select at least one optimal routing path for the at least one requested transaction from the plurality of available routing paths, as discussed in relation to FIG. 5. The selected routing path may be optimal in a sense that it may best accommodate the routing of the requested transaction in view of user preference (as manifested in the received preference weights 251).

In some embodiments, neural network 214 may be configured to repeat the selection of an optimal routing path a predefined number of times, each time excluding the selected routing path from the list of available paths 208, so as to produce a predefined number of selected optimal (e.g., in descending order) routing paths.

System 200 may include a perturbation module 215, configured to receive the first set of preference weights 251 and perturbate the value of one or more preference weights 251 so as to produce one or more perturbated sets of preference weights 251 (e.g., perturbated preference weights 215A), where each preference weight corresponds to a transaction parameter.

Pertaining to the same example, perturbation module 215 may receive the first set of preference weights, that may include the first preference weight value 251A, associated with the GC (e.g., the probability of success), and the second preference weight value 251B, associated with the cost metric (e.g., the currency conversion cost). Perturbation module 215 may perturbate or change the values of one or more preference weights to produce at least one perturbated set of preference weights, that may include different preference weight values than those of the first set of preference weights.

In some embodiments, perturbation module 215 may include a pareto front module 216. Pareto front module 216 may be configured to receive a plurality of preference weight sets (e.g., the first set of preference weights 251 and/or the one or more second, perturbated set of preference weights 215A) and extract a pareto front of the preference weight sets. In other words, pareto front module 216 may be configured to extract a minimal number of preference weight sets 215A that may still include the information diversity of the plurality of preference weight sets 215A.

For example, if one assumes the following:

A first set of preference weights may include weights such as [4, 7 and 10], and may respectively correspond to transaction parameters [A, B and C];
A second set of preference weights may include weights such as [4, 8 and 10], and may correspond to the same transaction parameters; and
A third set of preference weights may include weights such as [4, 19 and 10], and may correspond to the same transaction parameters. Pareto module may omit the second data set, as it may not provide additional information regarding selection of an optimal routing path in view of a user's preference for specific transaction parameters.

According to some embodiments, NN 214 may be configured to select an optimal routing path from the plurality of available routing paths, for each set of preference weights, as elaborated herein in relation to FIG. 5.

For example, for each set of the received set of preference weights and the one or more perturbated sets of preference weights, the preference weights (e.g., 251A, 251-B) may be input to NN 214 and NN 214 may produce a selection of an optimal routing path from the plurality of available routing paths.

Thus, NN 214 may select one or more optimal routing paths, where each such selection may be optimal in a sense that it may best accommodate a user's preferences in view of the available routing paths 208 and the specific respective set of perturbations 215A of preference weights.

In some embodiments, system 200 may include a combinatorial module 217, that may be configured to receive at least one of: the one or more selected routing paths from NN 214, and the first set of preference weights 251 (e.g., before perturbation), and to produce therefrom a routing scheme 217A, as elaborated herein.

Routing scheme 217A may include or may be a data structure (e.g., a table, a list or the like) that may include a list, e.g. an ordered list 217B, or group of the one or more selected routing paths, that may each have been selected by NN 214 as optimal routing paths in view of respective, specific preference weight sets (e.g., 251, 215). Routing module 209 may subsequently route the requested transaction through network 210 according to the routing scheme 217A, as elaborated herein, in relation to FIG. 5.

According to some embodiments of the invention, system 200 may be configured to attempt to route the requested transaction according to routing scheme 217A in a serial routing sequence (e.g., one after the other, according to ordered list 217B) of the one or more selected routing paths. For example, assume routing scheme 217A includes the following ordered list of routing paths 217B: e.g., routes [A, B and C]. Routing module 209 may be configured to attempt routing the requested transaction from the source node (e.g., element 202-a of FIG. 2) to the destination node (e.g., element 202-a of FIG. 2), according to the order of ordered list 217B. For example, routing module 209 may first try routing path A. If routing through routing path A fails, routing module 209 may attempt routing the requested transaction through the next routing path of ordered list 217B (e.g., routing path B) and then through C, etc. Routing module 209 may persist with the routing attempts in the order of ordered list 217B until a termination condition has been met.

The termination condition may be, for example, one of:

one of the routing attempts has been successful (e.g., a positive acknowledgement response from the destination node has been received by the source node);

a total timeframe (e.g., a “transaction timeframe”) for routing the requested transaction has elapsed;

a user has terminated the routing process (e.g., via input element 135 of FIG. 1); and the like.

The routing of the requested transaction may be regarded as failed in a sense that the source node may be in a condition where it lacks information on a successful reception of the transaction by the destination node. For example, a failure may be defined as a condition in which: no acknowledgement has been received from the destination within a predefined timeframe; a refusal has been received from one or more nodes included in the routing path (including the destination node); and/or the like.

Alternately or additionally, system 200 may be configured to attempt to route the requested transaction according to routing scheme 217A in a parallel routing sequence. For example, routing module 209 may be configured to attempt to route the requested transaction from the source node to the destination node through two or more routing paths concurrently or at substantially the same time (e.g., without awaiting an acknowledgement and/or refusal from any node in any of routing paths A, B and C).

In some embodiments, routing module 209 may be configured to implement any combination of such serial and/or parallel routing through network 210. For example, combinatorial module 217 may produce routing scheme 217A so as to configure routing module 209 to perform parallel routing (e.g., through both routing paths B and C) after a previous attempt to route the requested transaction via a single routing path (e.g., path A) has failed.

In some embodiments, routing module 209 may be configured to limit the routing of the requested transaction by one or more timeframes.

For example, a first timeframe may define a time period in which a single attempt to route the requested transaction (e.g., via routing path A) must be completed, so as not to be rendered as failed.

In another example, a second timeframe may define a total time period in which routing the transaction according to routing scheme 217A (e.g., through routing path A, and then through routing path B, etc.) must be completed, so as not to be declared or rendered as failed.

In some embodiments, the one or more timeframes may be set according to a configuration of network 210 (e.g., according to timeout definitions), as known in the art. Additionally, or alternately, one or more timeframes may be determined and input by a user (e.g., via element 135 of FIG. 1).

Combinatorial module 217 may produce routing scheme 217A, and set the order of the ordered list of routing paths 217B based on one or more of:

the value of the one or more timeframes;
the routing sequence (e.g., serial, parallel and/or combination thereof);
one or more transaction parameters; and
one or more preference weights, so as to optimize the routing of the requested transaction through network 210 in view of a user's preference.

For example, assume the following: a merchant may sell an item via an online website (e.g. node 202-a of FIG. 3). The merchant may need to settle the financial transaction through transfer of a monetary value, between the merchant's bank account handled in an acquirer bank (e.g. node 202-c of FIG. 3) and a consumer's bank account handled in an issuer bank (e.g. node 202-e of FIG. 3). The merchant may prefer to settle the transaction so as to maximize the expected revenue and may thus set a high preference weight to require maximal revenue.

The expected revenue of the transaction, when routed through a specific routing path may be calculated according to an expected revenue function, one example being expressed below, in Eq. 8:

Expected RevenueA=[P_{success,A}·(Payment−successful_transaction_fee_{A})]−[P_{failure,A}·failed_transaction_fee_{A}]. Eq. 8

where:

‘Expected Revenue_{A}’ may represent the expected revenue for an ME transaction that is routed via a specific routing path (e.g., path A);

‘Price’ may represent the monetary sum that the client is required to pay;

‘successful_transaction_fee_{A}’ may represent, for example, one of: any function of the price (e.g., percentage of the price), a fixed sum, and/or a transaction fee as described in Eq. 2, in relation to the respective routing path (e.g., path A);

failed_transaction_fee_{A} may represent, for example, one of: a function of the price (e.g., a percentage of the price) and/or a fixed sum, in relation to the respective routing path (e.g., path A); and

P_{success, A} and P_{failure, A} are the overall probabilities of a transaction success and failure through the respective routing path (e.g., path A), for example as described in Eq. 6A and Eq. 6B respectively.

For example, assume that a first routing path (e.g., path A) is characterized by a high probability of success (e.g., a high clearing rate by the credit card issuer, such as 80%) and a high successful transaction fee (e.g., 5% of the price, resulting in low revenue in the case of success) and a second routing path (e.g., path B) is characterized by a low probability of success (e.g., a low clearing rate by the credit card issuer, such as 60%) and a low successful transaction fee (e.g., 2% of the price, resulting in high revenue in the case of success). Combinatorial module 217 may consequently produce a scheme 217A that may have a serial routing sequence (e.g., one routing attempt after another), and have list, e.g. an ordered list, of routing paths 217B where path B is attempted before path A. In that way, path B that may be attempted by routing module 209 first, benefitting from the successful transaction fee and thus satisfying the merchant's preference of maximal revenue (as manifested by the high preference weight for revenue). Only if and after routing through path B fails, routing module 209 may attempt to route the requested ME transaction, to ensure that the sale will be materialized (albeit producing a reduced revenue).

In another example, assume that:

the merchant places higher preference to the realization of the sale over the revenue (and sets preference weights accordingly);
a third routing path (e.g., path C) is characterized by a medium probability of success (e.g., a medium clearing rate by the credit card issuer, such as 70%) and a medium successful transaction fee (e.g., 3% of the price, resulting in medium revenue in the case of success);
the probabilities of success for each of the routing paths are unrelated;
the total time for performing the ME transaction is limited by a timeframe (e.g., 30 seconds) that may be dictated by one or more components of network 210, as known in the art; and
routing paths A, B and C are respectively characterized by respective service time of 25, 15 and 10 seconds.

In this condition, combinatorial module 217 may not serially attempt routing the transaction through routing paths B and A, as in the previous example, because the overall amount of their expected service time (e.g., 25+15 seconds) may surpass the limit dictated timeframe (e.g., 30 seconds). The two options for serial routing may be [A] alone or [C followed by B]. Since the preference weights place higher importance to fruition or realization of the transaction over the revenue, an optimal selection of a routing scheme may accommodate a higher probability for realization of the sale (e.g., regardless of the revenue). As the probabilities of success for each of the routing paths are unrelated, the combined probability of success of either one of channels C or B may be calculated as 1-[(1−0.7)·(1−0.6)]=88%. So, even though routing path A has the highest probability of success (e.g., 80%) of the three paths, combinatorial module 217 may produce a scheme 217A that may include a serial sequence of routing, and an ordered routing list 217B that may include path C followed by path B, to obtain a routing scheme that is optimal in view of the merchant's preferences (e.g., as manifested in a high preference weight for realization of the ME transaction).

In another example, as elaborated in relation to Eq. 7A and Eq. 7B, processor 201 may accumulate information regarding conditions in which more than one attempt to route a requested transaction has taken place and to calculate a dependent success probability among the two routes. Pertaining to the example above, success of routing of a requested ME transaction through network 210 may be dependent among two or more paths. Such dependency may arise, for example, from a common hidden parameter. As an extreme example, assuming the client has insufficient funds in their bank account, an ME transaction may be declined by the destination node regardless of the selected routing path.

Combinatorial module 217 may receive one or more of the calculated dependent success probabilities and produce the routing scheme and configure ordered list 217B according to the dependent probability of success. Taking the calculated dependent probabilities into account may change one or more metrics for decision, upon which combinatorial module 217 may produce routing scheme 217A. For example, the calculation of revenue as elaborated in the example of Eq. 8, given the dependent success probability of two routing paths (e.g., first routing path A and second routing path B) may change, as expressed in one example below, in Eq. 9:

$$Expected {Revenue}_{A} = [ {P}_{success , A} \cdot ( \begin{matrix}Payment - \\ successful\_transaction {\_fee}_{A}\end{matrix} ) ] - [ \begin{matrix}{P}_{failure , A} \cdot \\ failed\_transaction {\_fee}_{A}\end{matrix} ] + [ {P}_{failure , A} \cdot \{ ( {Prob}_{success B \vert Failure A} ) \cdot ( \begin{matrix}Payment - \\ successful\_transaction {\_fee}_{b}\end{matrix} ) - \cdot ( {P}_{failure B \vert failure A} ) \cdot failed\_transaction {\_fee}_{B} ] \} ] \qquad Eq . 9$$

Of course, as more routing paths may be introduced into ordered list 217B, Eq. 9 may become increasingly complex, to include the contribution of additional components corresponding to the introduced routing paths.

Pertaining to the previous example of an ME transaction, if the probability of failure of routing transactions through routing paths C and B is high, combinatorial module 217 may deduce that attempting to route the transaction through path B after it had failed via path C may be pointless. Hence, combinatorial module 217 may configure ordered list 217B to include a different list of routing paths. For example, ordered list 217B may include a first attempt, to route the transaction through path C, and a second attempt, to route the transaction through path D, where D may have a lesser correlation to path C than the correlation of path B to path C. In other words, the dependent probability of success of path D in view of a failure of routing over path C may be higher than the dependent probability of success of path B upon failure of routing through routing path C.

According to some embodiments, combinatorial module 217 may be configured to edit or amend the routing scheme during the attempts to route the requested transaction through network 210.

Pertaining to the example above, if a routing of the requested transaction through a first routing path (e.g., path C) succeeds, then system 200 may cease and may not continue with additional routing attempts. If, on the other hand, the routing of the requested transaction through the first routing path (e.g., path C) fails, then combinatorial module 217 may amend the routing scheme 217 (e.g., a scheme that may include ordered routing list 217B [path C, path B]) according to the dependent probability of success of routing paths (e.g., Prob_{Success B|failure C}, Prob_{Success D|failure C}), so as to include an amended ordered list of routing paths 217B (e.g., [path C, path D]). Routing module 209 may subsequently route the requested transaction through the computer network according to amended ordered list of routing paths 217B (e.g., run the second attempt through path D, rather than through path B).

According to some embodiments, ordered list 217B may be ordered based on for example at least one of: a timeframe and/or a completion time of at least routing attempt.

For example, if a routing of the requested transaction through a first routing path (e.g., path C) fails, then combinatorial module 217 may amend or alter the routing scheme 217 (e.g., a scheme that may include ordered routing list 217B [path C, path B]) according to the expected time of service. For example, if the attempt to route the requested transaction through path C has taken longer than the expected service time for path C, and path B is characterized by a long expected service time that may surpass the transaction's timeframe, combinatorial module 217 may replace path B in ordered list 217B with another routing path (e.g., path D) that may be characterized by a shorter expected service time.

In another example, routing scheme 217A may include a parallel routing sequence, so as to attempt to route an ME transaction through a plurality (e.g., two or more) paths, substantially simultaneously (e.g., without awaiting a timeout to elapse or any type of an acknowledgement from a node of network 210), as elaborated herein.

Assume that a merchant has placed high preference to performing the transaction with maximal revenue (e.g., set a high value to a respective preference weight), and that a cancellation fee may be incurred in case of a transaction cancellation. In this condition, combinatorial module 217 may add an additional factor to the calculation of the revenue function, including a probability in which the transaction may succeed on more than one routing path, and an expected cancellation fee that may subsequently be incurred. Combinatorial module 217 may subsequently produce a routing scheme, that may include one or more routing paths that may be routed in a parallel sequence and may be selected upon the expected incurred cancellation fee.

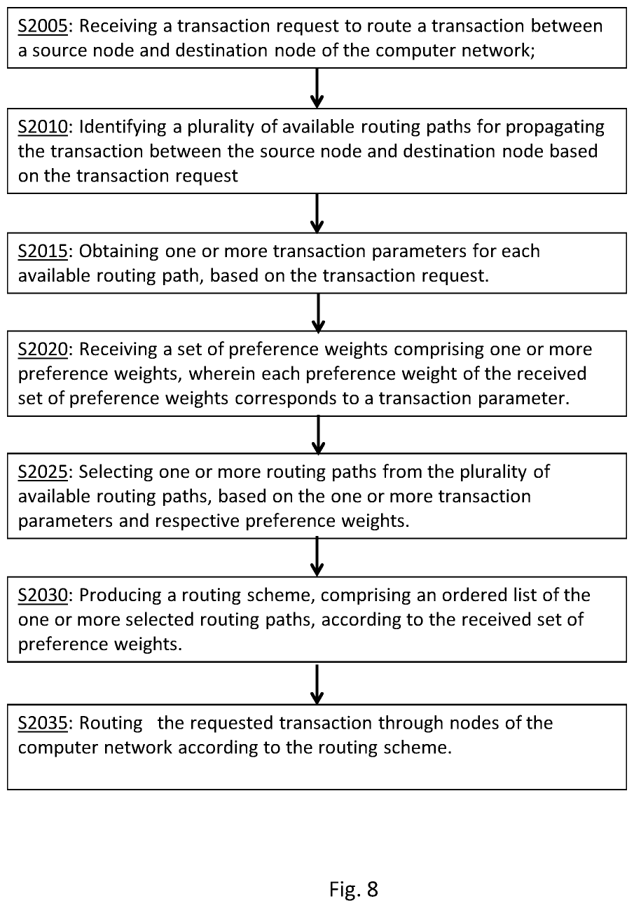

Reference is now made to FIG. 8, which is a flow diagram depicting a method of routing transactions through a computer network, by at least one processor, according to some embodiments of the invention.

As shown in step 2005, a processor (e.g., element 105 of FIG. 1) may receive a transaction request (e.g., element 206 of FIG. 2) to route a transaction between a source node (e.g., 202-a) and a destination node (e.g.: 202-c) of the computer network 210.

As shown in step 2010, the processor may identify a plurality of available routing paths (e.g., path A, path B of FIG. 2) for propagating the transaction between the source node and destination node based on the transaction request.

As shown in step 2015, the processor may obtain one or more transaction parameters (e.g., cost metric 252 of FIG. 5, FV 253 of FIG. 5, GC of FIG. 5) for each available routing path, based on the transaction request. For example, the processor may obtain at least one GC for each available routing path based on a membership of the routing path in a cluster, as explained herein in relation to FIG. 4.

As shown in step 2020, the processor may receive (e.g., from input element 135 of FIG. 1) a set of preference weights that may include one or more preference weights. Each preference weight of the received set of preference weights may correspond to a transaction parameter.

As shown in step 2025, the processor may select (e.g., by NN module 214 of FIG. 7) one or more routing paths from the plurality of available routing paths, based on the one or more transaction parameters and respective preference weights, as explained herein.

As shown in step 2030, the processor may produce (e.g., by combinatorial module 217 of FIG. 7) a routing scheme (e.g., element 217A of FIG. 7). The routing scheme may include an ordered list (e.g., 217B) of the one or more selected routing paths, according to the received set of preference weights, as explained herein in relation to FIG. 7.

As shown in step 2035, the processor may route (e.g., by routing module 209) the requested transaction through nodes of the computer network according to the routing scheme. Routing module 209 may route the requested transaction through by any appropriate routing protocol (e.g., RIP) as known in the art.

Embodiments of the present invention may provide a number of practically applicable improvements of routing transactions through a computer network, as known in the art of computer networking.

For example, embodiments may include selection of an optimal routing path for a requested transaction according to a plurality of transaction parameters, as elaborated herein, and according to at least one user preference.

Moreover, embodiments may include a dynamic selection of an ordered group or of routing paths, and a respective sequence of routing attempts (e.g., a serial sequence, a parallel sequence, and/or a combination thereof). The combination of the selection of routing paths, their order and the sequence of respective routing attempts, as explained herein, may provide an improvement over merely selecting a single routing path, as known in the art.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method of routing transactions within a computer network, by at least one processor, method comprising:
receiving a transaction request to route a transaction between a source node and destination node of the computer network;
identifying a plurality of available routing paths for propagating the transaction between the source node and destination node based on the transaction request;
obtaining one or more transaction parameters for each available routing path, based on the transaction request;
receiving a set of preference weights comprising one or more preference weights, wherein each preference weight of the received set of preference weights corresponds to a transaction parameter;
selecting one or more routing paths from the plurality of available routing paths, based on the one or more transaction parameters and respective preference weights;
producing a routing scheme, comprising an ordered list of the one or more selected routing paths, according to the received set of preference weights; and
routing the requested transaction through nodes of the computer network according to the routing scheme.

2. The method of claim 1, wherein obtaining one or more transaction parameters comprises:
extracting from the transaction request, a feature vector (FV), comprising at least one feature associated with the requested transaction;
associating the requested transaction with a cluster of transactions in a clustering model based on the extracted FV; and
attributing at least one group characteristic (GC) to the requested transaction, based on the association of the requested transaction with the cluster, wherein the one or more transaction parameters comprise at least one of: a feature of the FV and a GC parameter.

3. The method of claim 2, wherein obtaining one or more transaction parameters comprises calculating at least one cost metric, wherein the cost metric is selected from a list consisting of:
transaction success fees per at least one available route;
transaction failure fees per at least one available route;
transaction cancellation per at least one available route;
currency conversion spread per the at least one available route;
currency conversion markup per the at least one available route; and
net present value (NPV) of the requested transaction per the at least one available route, and wherein the one or more transaction parameters comprise at least one cost metric.

4. The method of claim 1, wherein selecting one or more routing paths from the plurality of available routing paths comprises:
providing at least one transaction parameter as a first input to a neural-network (NN);
providing at least one respective preference weight as a second input to the NN;
providing the plurality of available routes as a third input to the neural-network; and
obtaining, from the NN a selection of one or more optimal routing paths based on at least one of the first, second and third inputs.

5. The method of claim 4, further comprising:
perturbating a value of one or more preference weights of the received set of preference weights, to produce one or more perturbated sets of preference weights;
for each set of the received set of preference weights and the one or more perturbated sets of preference weights, providing the preference weights as the second input to the NN and obtaining, from the NN, a selection of an optimal routing path from the plurality of available routing paths.

6. The method of claim 1, wherein routing the requested transaction through nodes of the computer network according to the routing scheme comprises attempting to route the requested transaction in a serial sequence, one routing path after the other, according to the ordered list of the one or more selected routing paths.

7. The method of claim 1, wherein routing the requested transaction through nodes of the computer network according to the routing scheme comprises attempting to route the requested transaction in a parallel sequence, through two or more routing paths, according to the ordered list of the one or more selected routing paths.

8. The method of claim 1, wherein routing the requested transaction through nodes of the computer network according to the routing scheme comprises attempting to route the requested transaction in a combination of a parallel sequence and a serial sequence, according to the ordered list of the one or more selected routing paths.

9. The method of claim 1, wherein routing the requested transaction is limited by a timeframe, and wherein the ordered list is ordered based on at least one of: the timeframe and a completion time of at least routing attempt.

10. The method of claim 1, further comprising calculating a dependent probability of success between different routing paths and wherein the ordered list is ordered according to the calculated dependent probability of success.

11. The method of claim 9, further comprising:
if a routing of the requested transaction through a first routing path fails, then amending the routing scheme according to the dependent probability of success, so that the routing scheme comprises an amended ordered list of routing paths; and
routing the requested transaction through the computer network according to the amended ordered list of routing paths.

12. A system for routing transactions within a computer network, the system comprising: a non-transitory memory device, wherein modules of instruction code are stored, and at least one processor associated with the memory device, and configured to execute the modules of instruction code, whereupon execution of said modules of instruction code, the processor is further configured to perform at least one of:
receive a transaction request to route a transaction between a source node and destination node of the computer network;
identify a plurality of available routing paths for propagating the transaction between the source node and destination node based on the transaction request;
obtain one or more transaction parameters for each available routing path, based on the transaction request;
receive a set of preference weights comprising one or more preference weights, wherein each preference weight of the received set of preference weights corresponds to a transaction parameter;
select one or more routing paths from the plurality of available routing paths, based on the one or more transaction parameters and respective preference weights;
produce a routing scheme, comprising an ordered list of the one or more selected routing paths, according to the received set of preference weights; and
route the requested transaction through nodes of the computer network according to the routing scheme.

13. The system of claim 12, wherein the processor is configured to obtain one or more transaction parameters by:
extracting from the transaction request, a feature vector (FV), comprising at least one feature associated with the requested transaction;
associating the requested transaction with a cluster of transactions in a clustering model based on the extracted FV; and
attributing at least one group characteristic (GC) to the requested transaction, based on the association of the requested transaction with the cluster, wherein the one or more transaction parameters comprise at least one of: a feature of the FV and a GC parameter.

14. The system of claim 13, wherein the processor is configured to obtain one or more transaction parameters by calculating at least one cost metric and wherein the cost metric is selected from a list consisting of:
transaction success fees per at least one available route;
transaction failure fees per at least one available route;
transaction cancellation per at least one available route;
currency conversion spread per the at least one available route;
currency conversion markup per the at least one available route; and
net present value (NPV) of the requested transaction per the at least one available route, and wherein the one or more transaction parameters comprise at least one cost metric.

15. The system of claim 12, wherein the processor is configured to select one or more routing paths from the plurality of available routing paths by:
providing at least one transaction parameter as a first input to a neural-network (NN);
providing at least one respective preference weight as a second input to the NN;
providing the plurality of available routes as a third input to the neural-network; and
obtaining, from the NN a selection of one or more optimal routing paths based on at least one of the first, second and third inputs.

16. The system of claim 15, wherein the processor is further configured to:
perturbate a value of one or more preference weights of the received set of preference weights, to produce one or more perturbated sets of preference weights;
for each set of the received set of preference weights and the one or more perturbated sets of preference weights, provide the preference weights as the second input to the NN and obtain, from the NN, a selection of an optimal routing path from the plurality of available routing paths.

17. The system of claim 12, wherein the processor is configured to route the requested transaction through nodes of the computer network according to the routing scheme by attempting to route the requested transaction in a serial sequence, one routing path after the other, according to the ordered list of the one or more selected routing paths.

18. The system of claim 12, wherein the processor is configured to route the requested transaction through nodes of the computer network according to the routing scheme by attempting to route the requested transaction in a parallel sequence, through two or more routing paths, according to the ordered list of the one or more selected routing paths.

19. The system of claim 12, wherein the processor is configured to route the requested transaction through nodes of the computer network according to the routing scheme by attempting to route the requested transaction in a combination of a parallel sequence and a serial sequence, according to the ordered list of the one or more selected routing paths.

20. The system of claim 12, wherein routing the requested transaction is limited by a timeframe, and wherein the processor is configured to order the ordered list based on at least one of: the timeframe and a completion time of at least routing attempt.

21. The system of claim 12, wherein the processor is configured to calculate a dependent probability of success between different routing paths and wherein the ordered list is ordered according to the calculated dependent probability of success.

22. The method of claim 20, wherein the processor is configured to:
if a routing of the requested transaction through a first routing path fails, then amend the routing scheme according to the dependent probability of success, so that the routing scheme comprises an amended ordered list of routing paths; and
route the requested transaction through the computer network according to the amended ordered list of routing paths.

23. A method of routing transactions within a computer network, by at least one processor, method comprising:
receiving a transaction request to route a transaction between a source node and destination node of the computer network;
receiving a set of preference weights comprising one or more preference weights, wherein each preference weight of the received set of preference weights corresponds to a transaction parameter;
producing a routing scheme, comprising an ordered list of one or more selected available routing paths, according to the received set of preference weights; and
routing the requested transaction through nodes of the computer network according to the routing scheme.

24. The method of claim 23 wherein one or more preference weights correspond to one or more parameters selected from a group comprising: a feature vector (FV) parameter; a group characteristic (GC) parameter; a cost metric parameter; an expected revenue; and a transaction timeframe;
